(19) United States
(12) Patent Application Publication
(10) Pub. No.: US 2006/0243466 A1
(43) Pub. Date: Nov. 2, 2006

(54) Ground breaking apparatus

(76) Inventors: Larry D. Beller, Noble, OK (US); Martin Holland, Norman, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/118,518

(22) Filed: Apr. 29, 2005

(51) Int. Cl. A01B 5/00

(52) U.S. Cl. 172/518

(57) ABSTRACT

A ground breaking apparatus has a vehicle with a cutter assembly attached thereto. The cutter assembly has a rotating cutter mounted to a cutter housing which is attached to and movable with the vehicle. The cutter housing has a forward door that moves between open and closed positions. A pusher bar is movable between an operating and a raised position is also included. When the door is open and the pusher bar is in the operating position, the vehicle moving forward will cause the pusher bar to engage trees which will also be engaged and cut, or ripped by the rotating cutter. The door may be closed in the direction the vehicle reversed. The cutter may be lowered so that as the vehicle moves in reverse, the rotating cutter head mulches trees into the soil and also breaks up ground fragments to prepare the soil for the desired use.

### BACKGROUND OF THE INVENTION

This invention relates to a ground breaking apparatus and more particularly to a ground breaking apparatus that is capable of clearing trees and breaking ground surfaces into fragments and pieces.

There are a number of industries, for example the construction industry and road construction industry, where it is necessary to clear land of trees and to pulverize or grind hard ground surfaces to prepare the ground for construction or other desired purpose, such as preparation of the ground for road building. There are a number of machines adapted to break up hard ground surfaces such as asphalt, frozen ground, rock and other surfaces. Typically, the machines are vehicles with a rotating cutting apparatus attached thereto that will grind or break up the ground surface. U.S. Pat. No. 5,259,692, the details of which are incorporated herein by reference, discloses a ground breaking apparatus that may be attached to a vehicle and includes a rotating drum with cutter teeth thereon for the purpose of grinding or breaking the ground. There are other known machines used for breaking up a ground surface into pieces.

There are also a number of different types of equipment available to clear trees from property. Typically, several pieces of equipment are required to clear trees. Initially, large, expensive equipment is required to cut the trees. If the trees are to be moved, a second piece of equipment is required to move the trees. If the trees are to be disposed of, chippers or other equipment to grind the trees is necessary. Thus, to clear property of trees and to prepare the surface for construction of roads or for other purposes, several pieces of equipment are typically required to clear the trees, move and/or dispose of the trees and to grind and break up the ground in preparation for the construction. There is a need for an apparatus that will effectively break up hard ground surfaces, and that will, when necessary, also clear trees, to eliminate the need for numerous pieces of equipment used to accomplish the same purpose.

### SUMMARY OF THE INVENTION

The present invention comprises a ground breaking apparatus which includes a cutter assembly that may be attached to a vehicle. In the preferred embodiment, the cutter assembly is attached to a track type vehicle for movement therewith. The cutter assembly has a cutter shell surrounding at least a portion of a cutter head. The cutter head comprises a cutter drum with a plurality of cutter teeth thereon.

A shell door, or cutter door is pivotably attached to the cutter shell and is movable between open and closed positions. A pusher bar is pivotably attached to the cutter shell and movable between a raised or elevated position and a lowered, or operating position.

The ground breaking apparatus may be utilized to clear trees, mulch and blend cut trees into the soil and/or prepare ground surfaces for desired uses such as construction or road building by breaking up the ground into ground fragments or pieces. The height of the cutter assembly is adjustable and may be adjusted utilizing hydraulic cylinders. Likewise, the door and the pusher bar are preferably moved utilizing hydraulic cylinders.

If it is desired to clear trees, the vehicle to which the cutter assembly is attached will be moved forward and the cutter head will rotate in what will be referred to as a forward direction, in which the cutter drum is rotating into and toward trees, and other upstanding objects and debris as the vehicle moves in a forward direction. The cutter door will be open and the pusher bar will be in its lowered, or operating position so that the pusher bar will engage trees and other objects. The pusher bar will typically engage a tree prior to the time the rotating cutter head engages the tree and cuts, rips or tears the tree down. The cutter head may be positioned at a height so that the cutter teeth engage the ground surface and cut into the ground surface a desired depth.

Once a desired length of land has been cleared of trees, the cutter door may be closed and the pusher bar elevated. The direction of the carrying vehicle may be reversed while the cutter head continues to rotate in the forward direction. If desired, the cutter head may be lowered so that the cutter teeth cut into the ground to a greater desired depth, for example as much as eight or more inches. The rotating cutter teeth will mulch felled trees into the soil as the vehicle moves in the reverse direction. The cutter teeth will also engage and break up the ground and move pieces of the ground into the cutter shell where they will be engaged by wear plates that are attached to the cutter shell. The ground pieces will be broken into small ground pieces and ground fragments and thus the ground may be prepared for the desired use such as road construction or other desired use.

The wear plates attached to the cutter shell are removable wear plates, and are positioned and oriented so that the wear plates will engage pieces carried by the cutter teeth when the cutter head is rotating in the forward direction. The rotational direction of the cutter head may be reversed by rotating the cutter head end to end in the cutter shell. The cutter assembly also includes removable wear plates that will engage ground pieces carried by the cutter teeth when the cutter head is rotating in the reverse direction. Thus, the cutter shell has a plurality of wear plates attached thereto positioned and oriented so that ground pieces carried by the cutter head will engage wear plates to break ground pieces into smaller ground pieces and ground fragments when the cutter head is rotating in either the forward or the reverse direction.

### BRIEF DESCRIPTION OF THE DRAWINGS

FIG. 1 schematically shows a side view of the ground breaking apparatus of the present invention.

FIG. 2 is a perspective view of the ground breaking apparatus of the current invention with a pusher bar in a raised position and the shell door closed.

FIG. 3 is a perspective view showing the ground breaking apparatus with the pusher bar in its lowered position and the shell door open.

FIG. 4 is a view looking down showing the connection of the vehicle to the cutter shell.

FIG. 5 is an exploded view of the left side of the cutter assembly.

FIG. 6 is an exploded view of the right side of the cutter assembly.

FIG. 7 shows the cutter door and connecting pieces.

FIG. 8 is a view taken from the direction of line 8-8 of FIG. 4 and shows the connection of the cutter door to the shell.

FIG. 9 is a view taken from the direction of line 9-9 in FIG. 5 and shows the connection of the pusher bar to the cutter shell.

FIG. 10 is a view taken from the direction of line 10-10 in FIG. 4 and shows the connection of the vehicle to the cutter assembly looking down at the shell.

FIG. 11 is a cross-section view from line 11-11 of FIG. 5.

FIG. 12 is a cross-sectional view of the cutter shell from the direction of line 12-12 in FIG. 5.

FIG. 13 is a front view of an adapter plate.

FIG. 14 is a cross-section view of the wobble plate.

FIG. 15 is a cross-section view of a adapter plate of the current invention.

### DETAILED DESCRIPTION OF THE PREFERRED EMBODIMENT

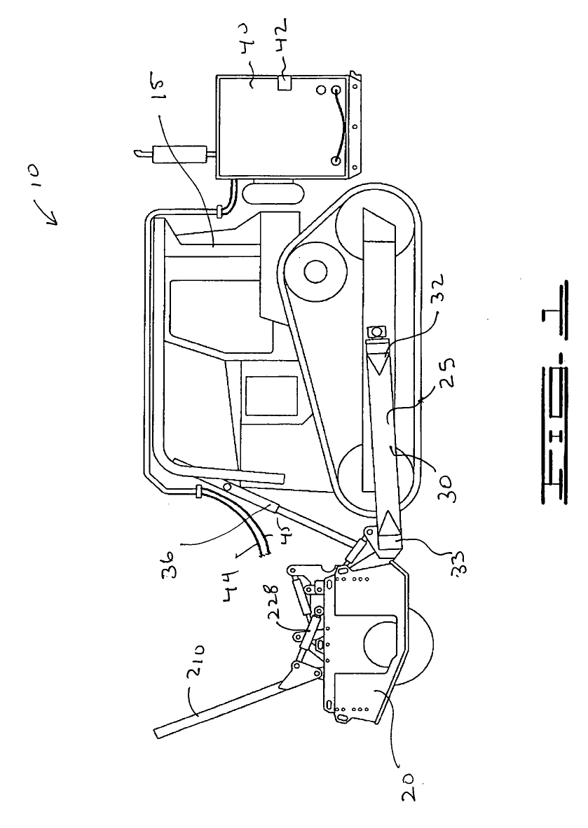

Referring to the drawings and more particularly to FIG. 1, ground breaking apparatus 10 comprises a vehicle 15 which may be a wheeled or track vehicle with a cutter assembly 20 attached thereto. In the embodiment shown, vehicle 15 is a track type vehicle which may be of a type known in the art, and is of a type adapted to carry equipment connected thereto, such as a front end loader, grader blade or other equipment.

Cutter assembly 20, which may also be referred to as a ground breaking assembly 20, is connected to vehicle 15 with a C-frame 25. C-frame 25 has a pair of legs 30 which have rear ends 32 and forward ends 33. A cross member 34 is connected to and extends between legs 32 at forward ends 33. A pair of hydraulic cylinders 36 on vehicle 15 are mounted to lugs 38 on cross member 34. Hydraulic cylinders 36, as is known in the art, may be used to lift and/or lower C-frame 25 and, because C-frame 25 is connected to cutter assembly 20, will lift and lower the cutter assembly 20. Vehicles of the type described herein generally carry such hydraulic cylinders, and have a C-frame to connect to front end equipment. C-frame 25 will preferably be a modified C-frame, in that it will be strengthened structurally so that the cutter assembly 20 is adequately supported.

An auxiliary engine unit 40, is mounted to vehicle 15 and carried therewith. At least one and preferably two variable volume hydraulic pumps 42 are powered by auxiliary eengine unit 40. Hydraulic pumps 42 are used to supply fluid to hydraulic motors which will be utilized to rotate the cutter portion of cutter assembly 20 as will be explained in more detail hereinbelow. Hydraulic lines 44 and 45 extend from a manifold (not shown) into which pumps 42 supply fluid. One of lines 44 and 45 will be a supply line, and the other will be a fluid return line. Additional hoses which may serve as drain hoses, or for other purposes, may also be included.

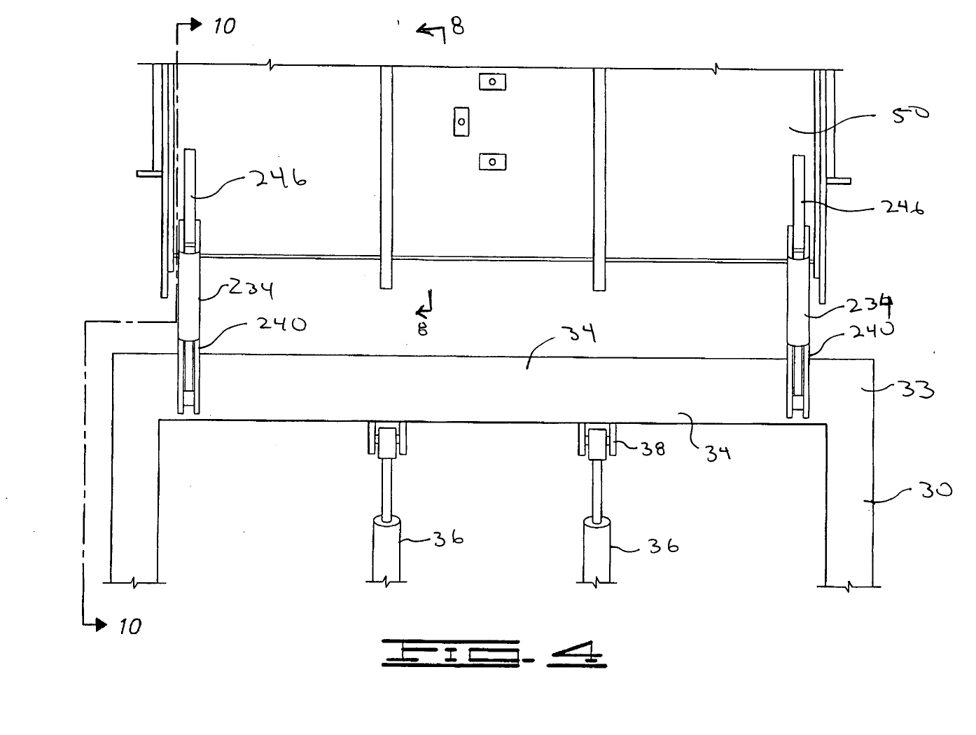

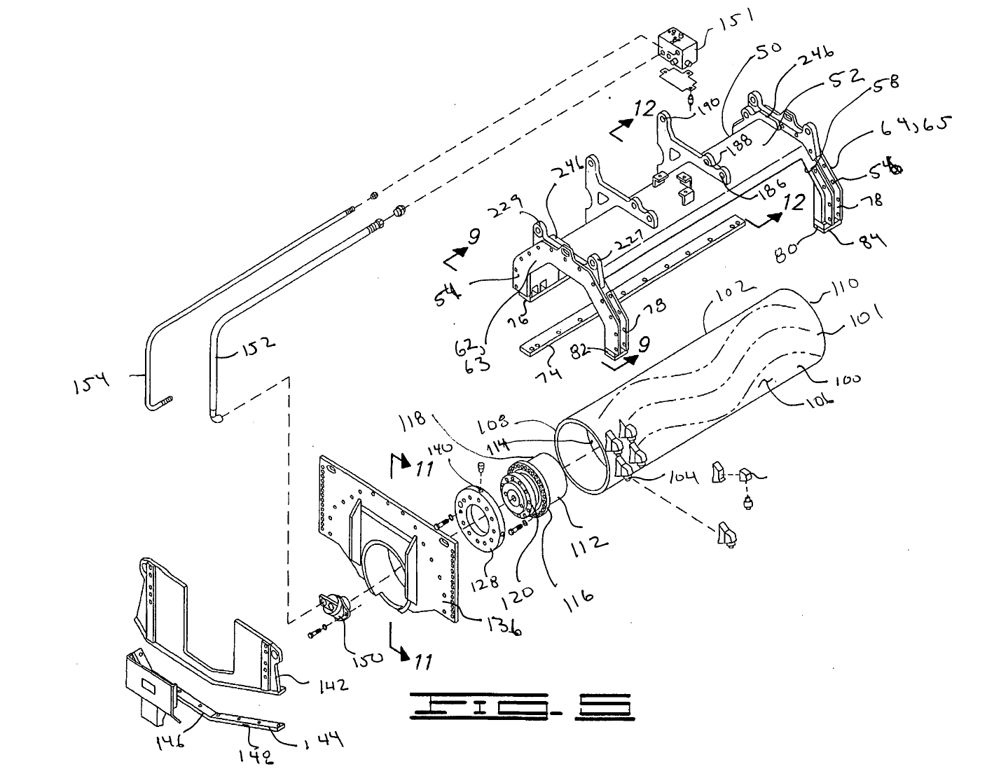

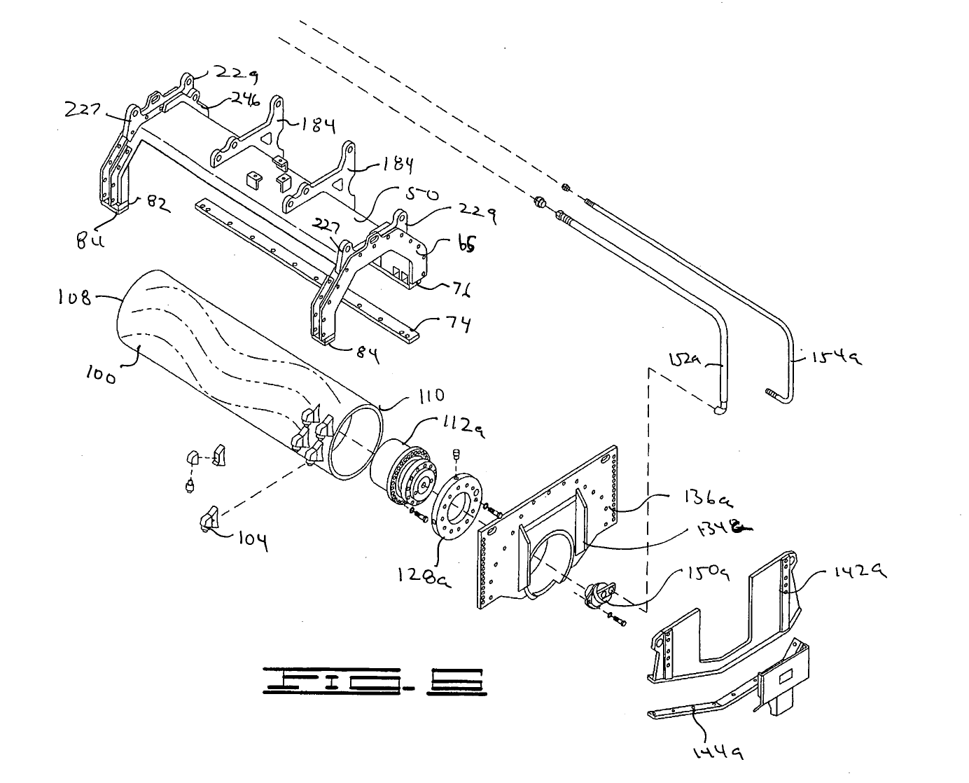

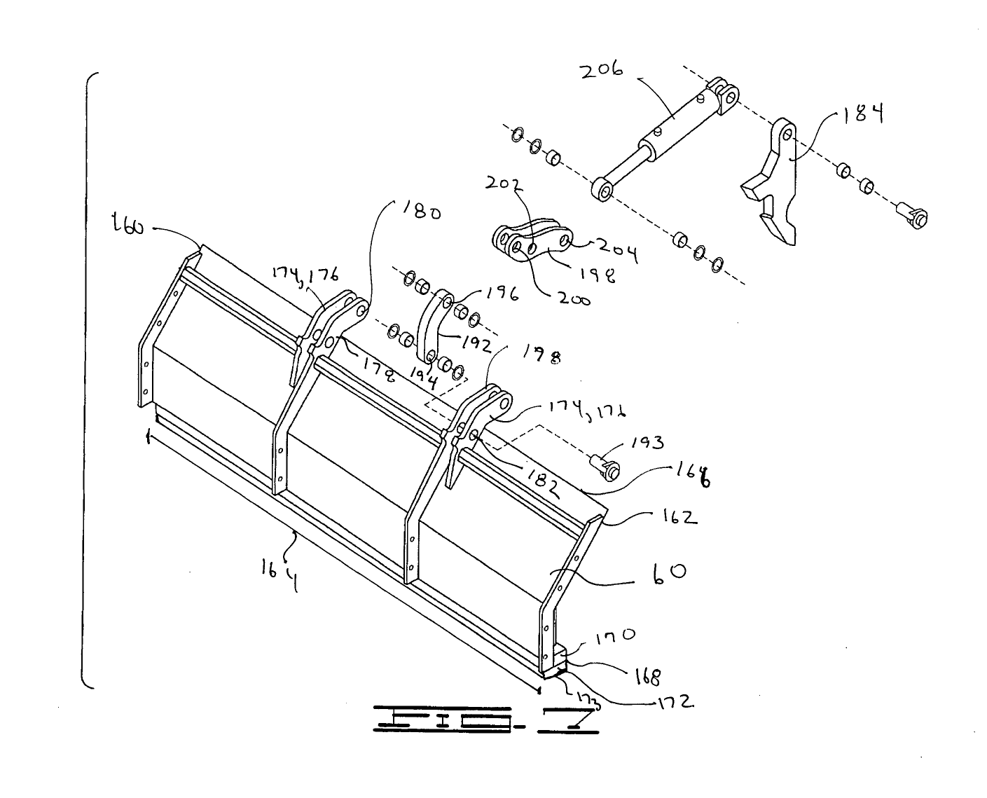

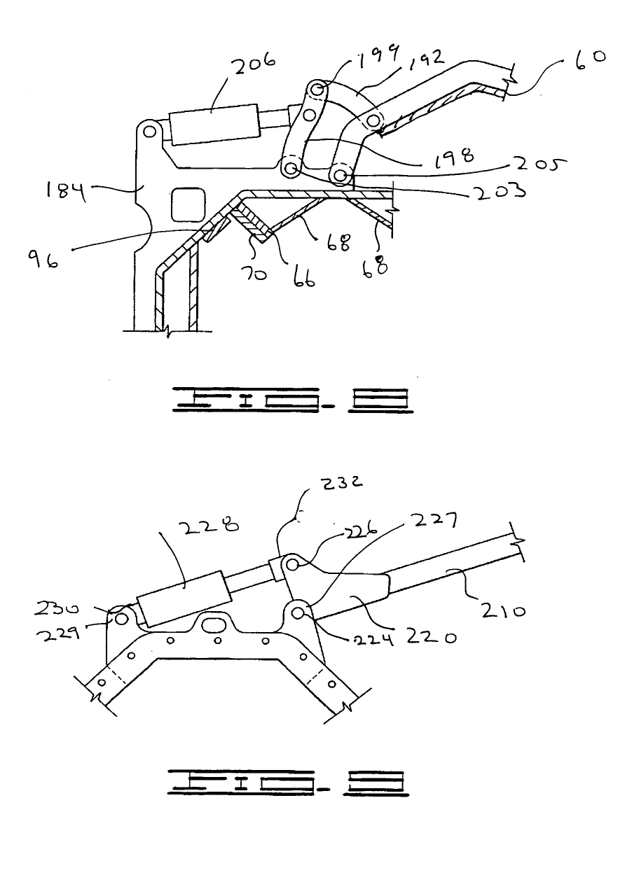

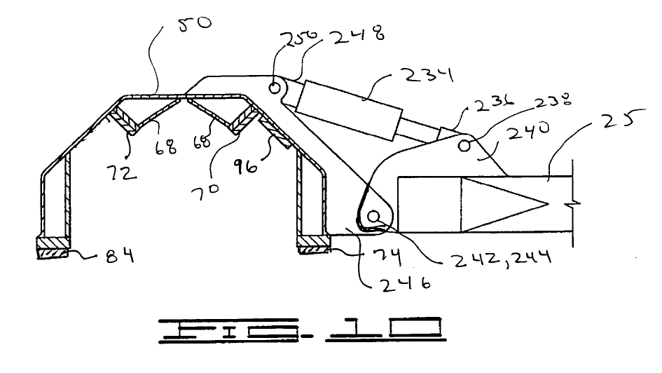

FIGS. 5 and 6 show the details of the cutter assembly 20. FIG. 5 is an exploded view showing the left side, as viewed from the front of the vehicle and FIG. 6 is the right side. Details will be described with respect to the left side and similar pieces on the right side will be given numeric designations identical to parts on the left side with a subscript a. Cutter assembly 20 includes a cutter housing or cutter shell 50. Cutter housing 50 is generally shaped as a half hexagon and thus has a top 52, a rear portion 54 and a forward portion 56. A cutout 58 is defined in the forward portion 56 and is covered by a door 60, which is shown in FIG. 7 and which is connected to cutter housing 50. Cutter shell 50 has first or left end 62 with a connecting plate 63 and second or right end 64 with a connecting plate 65.

A cross-sectional view of cutter shell 50 is shown in FIG. 12. A plurality of mounting plates 66 are attached to cutter shell 50 and are supported by support braces 68. A wear plate 70 is removably attached to one of mounting plates 66 and a wear plate 72 is removably attached to the other of mounting plates 66. A wear plate 74 is attached to a mounting plate 76 that is positioned along the bottom of rear portion 54 and extends along substantially the entire length of cutter shell 50. Mounting plates 66, and removably attached wear plates 70 and 72 likewise extend substantially the full length of cutter shell 50. A pair of legs 78 with lower ends 80 are defined by cutout 58 in the forward portion 56 of shell 50 and each has a mounting plate 82 connected thereto. Each mounting plate 82 has a downward facing wear plate 84 removably connected thereto.

Wear plates 70 and 72 have wear faces 88 and 90, respectively, and are positioned on opposite sides of a center line 86. Wear plate 74 and wear plates 84 are downward facing wear plates that are positioned on opposite sides of a center line 86, and have wear faces or wear surfaces 92 and 94, respectively. Wear faces 88 and 90 define planes that when viewed in the cross section in FIG. 12 intersect to form a generally right angle. Cutter shell 50 thus has wear plates oriented and positioned so that any ground fragments, or tree debris, or other material carried into cutter shell 50 will be impacted by a wear plate regardless of the direction the ground fragments are being carried by the rotating cutter head. At least one wear plate 96, with a wear surface 97, is removably attached to an inner surface 98 of cutter shell 50, and will also engage material carried into the cutter shell. All of the wear plates are preferably made from a wear-resistant metal, such as a hardened steel.

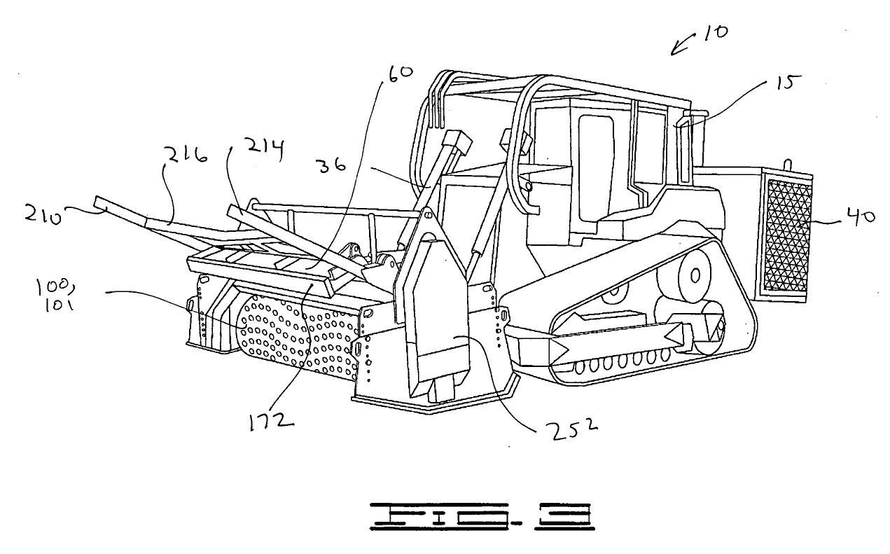

Cutter assembly 20 includes a cutter head 100 rotatably mounted in cutter shell 50. Cutter shell 50 partially covers cutter head 100, but leaves the bottom of the cutter head exposed. A forward portion 101 of the cutter head is also exposed when cutter door 60 is in an open position, as shown in FIG. 3. Cutter head 100 comprises a cutter drum 102 with a plurality of cutter teeth 104 fixed thereto. Teeth 104 project outwardly from an outer surface 106 of cutter drum 102 and are arranged in a double helix pattern, as indicated by the dashed lines in FIG. 5, with an effective spacing between teeth of for example approximately 1.5 to 2 inches, and preferably about 2 inches. Cutter head 100 has first or left end 108 and second or right end 110.

A planetary drum drive 112 is mounted to a flange 114 that is fixed to cutter drum 102. A mounting flange 116 of planetary drum drive 112 is fixed to flange 114. Mounting flange 116, along with drum 118 will rotate while a second, or adapter flange 120 on planetary drum drive 112 will remain stationary.

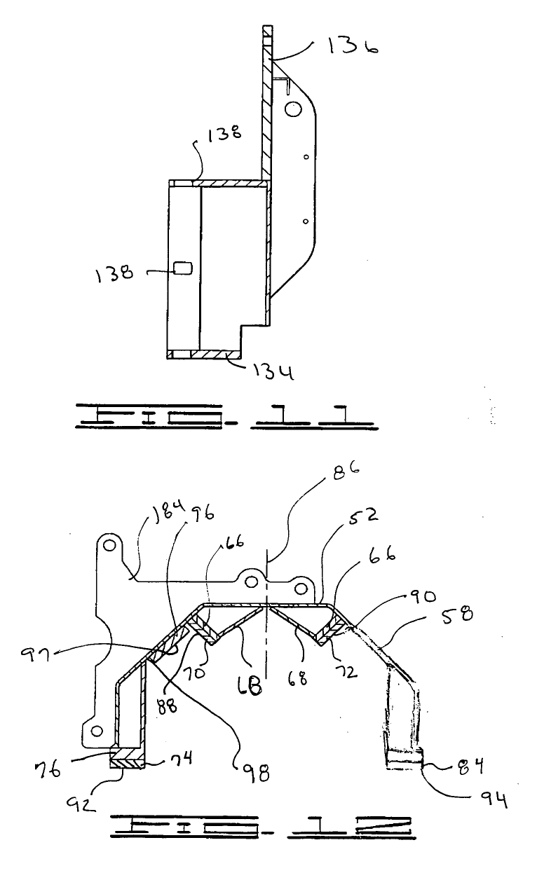

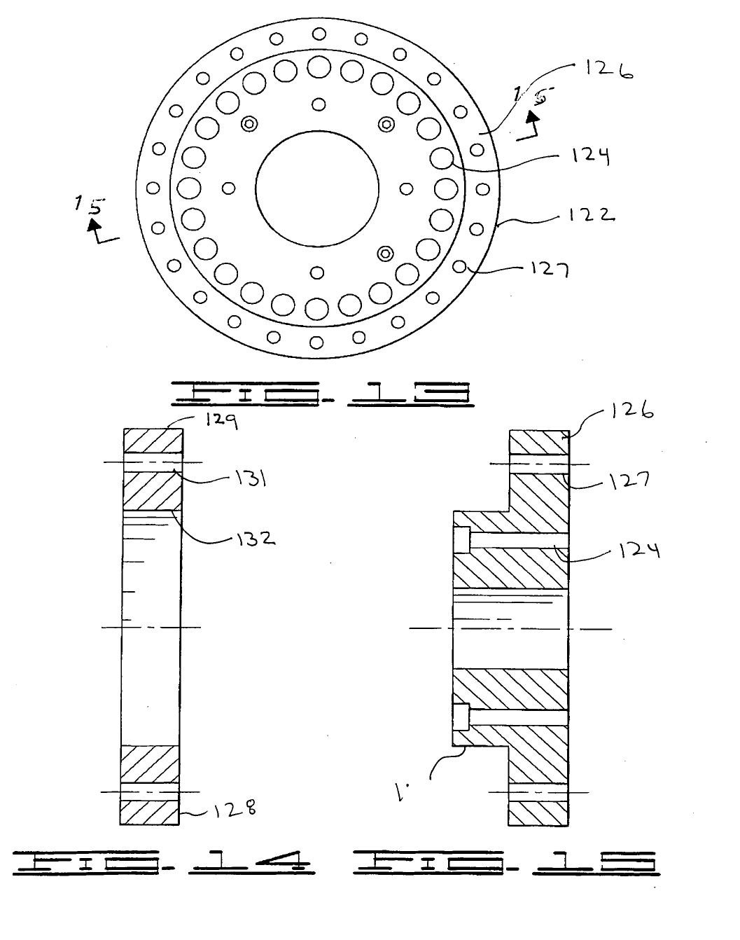

A spacer, or adapter 122, which is shown in FIG. 13, may be mounted to flange 120 through openings 124. Spacer 122 has an outer ring 126 with openings 127 which may then be mounted to a wobble plate 128. One embodiment of a wobble plate for use with the current invention is shown and described in U.S. patent application Ser. No. 10/717,114, the details of which are incorporated herein by reference. The wobble plate 128 of the current invention is of a different configuration than the wobble plate shown in the prior application. Wobble plate 128 is generally disk shaped, with an outer edge 129 that may be slightly arcuate, as opposed to a straight edge. A plurality of openings 131 are defined through wobble plate 128 for connection to spacer 122.

An inner ring 130 on spacer 122 will extend at least partially through a central opening 132 of wobble plate 128. Wobble plate 128 is connected to spacer 122 with fasteners through openings 131 and corresponding openings 127 in spacer 122. Wobble plate 128 is mounted to a support housing 134 which is connected by welding or other means to an end plate 136. End plates 136 and 136a are attached to cutter shell 50 by fastening with bolts or other means to end plates 63 and 65. Support housing 134 has a plurality, and preferably four slots 138 through which fasteners, bolts or other connectors are inserted into corresponding openings 140 in wobble plate 128.

A shoe 142 is connected with bolts or by other means known in the art to end plate 136 and a shoe skid 144 is connected to the bottom of shoe 142. Skid 144 has a generally horizontal portion 146 and a portion that angles upwardly therefrom 148.

Hydraulic motor 150 is connected to planetary drum drive 112 and is used to rotate cutter head 100. Hydraulic motor 150 may be for example a high speed motor that rotates at about 2100 rpm. Planetary drum drive 112 will reduce rotational speed to about between 100 and 140 rpm. The numbers given are exemplary, and are not intended to be limiting. In addition, a high torque, low speed motor may be used instead of the high speed motor and planetary reducer arrangement described herein. Motor 150 and planetary drum drive 112 may be connected with a splined or other means known in the art. Motor 150 is mounted to spacer 122 and extends therethrough to connect to planetary drum drive 112.

Fluid is supplied to hydraulic motor 150 from a manifold 151 through an inlet hose 152. Fluid is expelled from motor 150 through an outlet hose 154 connected thereto. Manifold 151 may also include drain hoses, and is mounted to top portion 52 of cutter shell 50 and receives fluid through hydraulic line 44. Fluid returns are delivered from manifold 151 through hydraulic line 45. Hydraulic fluid is communicated into tube 144 from a manifold (not shown) mounted to vehicle 15 which receives hydraulic fluid from the two hydraulic pumps 42. The fluid is split by manifold 151 between hydraulic motors 150 and 150a.

Both of motors 150 and 150a will drive cutter head 100. The longitudinal center lines of motors 150 and 150a are preferably collinear, to prevent any off-center rotation of cutter head 100. Any misalignment that may exist in the center lines of the motors is accounted for by wobble plate 128 which will move due to its slotted connecting openings 138 and thus will allow movement of the ends 62 and 64 of the cutter head 100. The direction of rotation of cutter head 100 can be counterclockwise (the forward direction), when viewed in FIG. 1, or can be reversed so that the rotation is clockwise, by reversing the cutter head end to end in the cutter shell 50, and reversing the hydraulic connections on the motors 150 and 150a. The hydraulic lines will be connected with fittings, couplings and connectors by means known in the art.

Cutter door 60 has left end 160, right end 162 and a length 164 extending therebetween. Door 60 has upper end or upper edge 166 and lower edge 168. A mounting plate 170 is mounted to and extends along length 164 at lower end 168 and has a removable wear plate 172 attached thereto, with wear surface 173 thereon. Cutter door 60 is shaped to cover opening 58 in shell 50 when door 60 is attached thereto.

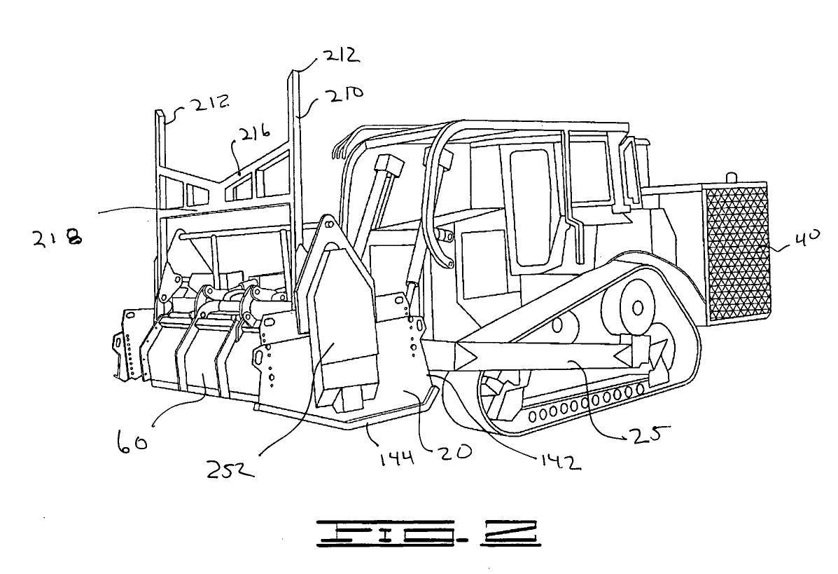

Two sets of mounting brackets 174 are utilized to pivotably mount door 60 to cutter shell 50. Each set of brackets 174 comprises an outer bracket 176 and an inner bracket 178. Brackets 176 and 178 have aligned rear openings 180 and aligned forward openings 182. Cutter door 60 is connected to cutter shell 50 at door attachment plates 184, which are connected to cutter shell 50. Door attachment plates 184 have forward openings 186, intermediate openings 188 and rear openings 190. As is understood from the drawings, both sets of mounting brackets 174 are utilized to connect cutter door 60 to both of door attachment plates 184 in the manner described herein. A knuckle 192 is pivotably connected to mounting brackets 174 with a pin 193 that extends through openings 182, and a first opening 194 in knuckle 192. Knuckle 192 has a second opening 196. A second knuckle 198 has first or forward openings 200, second or intermediate openings 202 and third or rear openings 204. First knuckle 192 is connected to second knuckle 198 with a pin 199 that extends through second opening 196 in first knuckle 192 and forward opening 200 in second knuckle 198. Each second knuckle 198 is connected to a door attachment plate 184 with a pin 203 that extends through openings 204 in second knuckle 198 and intermediate opening 188 in door attachment plate 184. Cutter door 60 is attached to cutter shell 50 with pins 205 that extend through openings 180 in mounting brackets 174 and forward openings 186 in door attachment plate 184. Hydraulic cylinders 206 are connected at one end to rear opening 190 in door attachment plate 184 and to intermediate opening 202 in second knuckle 198. Hydraulic cylinders 206 are utilized to move cutter door 60 between open and closed positions as shown in FIGS. 2 and 3, respectively. Hydraulic cylinders 206 may be controlled and powered by a means known in the art (not shown). For example, cylinders 206 may be powered by pumps on the auxiliary motor 40, and controlled by an operator of the vehicle with controls known in the art in the cab of vehicle 15.

A pusher bar 210 is pivotably mounted to cutter shell 50 at the ends 62 and 64 thereof. Pusher bar 210 has outer arms 212 and a pusher member 216 extending therebetween. Pusher bar 210 may also have a cross brace 218 to add support and strength to pusher bar 210. Each arm 212 has a lug 220 attached to a connecting end 222 thereof. Lug 220 has first opening 224 and second opening 226. First opening 224 is pinned to a lug 227 on cutter shell 50. Hydraulic cylinders 228 have a first end 230 connected to a lug 229 on cutter shell 50 and a second end 232 connected to lug 220 at second opening 226. Hydraulic cylinders 228 are controlled and powered by means known in the art as described herein and is utilized to move pusher bar 210 between its upright or raised position and its lowered or operative position shown in FIGS. 2 and 3, respectively. FIGS. 2 and 3 show the apparatus 10 with a protective cover 231 which prevents debris from interfering with the operation of motor 150.

C-frame 25 is connected to cutter shell 50 with hydraulic cylinders 234. Cylinders 234 are connected at one end 236 through an opening 238 in a lug 240 on C-frame 25. Lug 240 has a forward opening 242 which is pinned to a rear opening 244 of a lug 246 that is mounted at or near the end of cutter shell 50. A second end 248 of hydraulic cylinder 234 is pinned or connected through a forward opening 250 of lug 246 that is rigidly fixed to cutter shell 50. Thus, C-frame 25 is pivotably connected to cutter shell 50 with hydraulic cylinders 234, and at the connections between lugs 240 and 246. Hydraulic cylinders 234 are controlled and powered by means known in the art. For example, all of cylinders 206, 228 and 234 may be driven by hydraulic pumps connected to auxiliary engine unit 40 and operated by the operator of the vehicle with known hydraulic controls.

Ground breaking apparatus 10 can be utilized for the preparation of construction sites, clearing land and a variety of other functions. Ground breaking apparatus 10 is shown in FIG. 3 with pusher bar 210 in a lowered or operating position and cutter door 60 in an open position. Hydraulic fluid is supplied to hydraulic motors 150 so that cutter head 100 is rotated. With the door 60 in the open position and pusher bar 210 in the operating position, ground breaking apparatus 10 may be moved in the forward direction with the cutter head rotating in the forward direction, indicated by arrows 252 which is counterclockwise in the schematic shown in FIG. 1. Pusher bar 210 will engage trees and other upstanding objects and cause them to bend forward, and cutter teeth 104 on cutter drum 102 will rip and shred trees and any stumps over which cutter head 100 passes.

Once a desired length of land has been cleared of trees and/or stumps which will have been ripped, torn and chopped by the rotating cutter head 100, the direction of vehicle 15 can be reversed, while maintaining the direction of cutter head rotation. Cutter door 60 will be moved to its closed position and pusher bar 210 will typically be raised or elevated to its elevated position. Cutter head 100 will continue rotating in a counterclockwise direction as viewed in FIG. 1. Typically, whether cutter door 60 is open or closed, skid shoes 142 rest upon the ground, and thus control the depth of the cutter head 100. The skids 144 can be raised or lowered, to adjust the cutter depth so that the cutter skirts the ground or cuts into the ground a depth of as much as 8 to 12 inches.

If desired, hydraulic cylinders 234 which connect C-frame 25 to cutter housing 50 may be raised so that the skids are not on the ground, which will also adjust the height of the cutter head 100, and thus the depth of the cut. With cutter head 100 rotating in the direction described and vehicle 15 moving rearwardly, cutter head 100 will mulch the tree and stump debris into the soil and will also break up rocks, ice or other ground materials into smaller ground fragments. Cutter teeth 102 will dig into the soil, and will pick up fragments which will be engaged by removable wear plates 70 and 74 as cutter 100 rotates in the counterclockwise direction viewed in FIG. 1. The impact into the wear plates 70 and 74 will cause the debris to be broken into smaller ground fragments. As described herein, wear plates 70 and 74, and the other wear plates described herein are removably attached with fasteners or other means to allow quick and easy removal and replacement, since the constant impact on the wear plate will necessitate periodic replacement. All of the wear plates described herein are preferably comprised of a hardened, wear-resistant material. Thus, the debris including tree and stump debris, and rock or other ground material is processed in cutter housing 50 into small fragments that leave a prepared surface for construction or other desired uses.

In those instances where land is cleared of trees and it is simply desired to break up frozen ground, reclaim asphalt or simply to repair rocky soil, the ground breaking apparatus 10 is utilized in the manner herein described with cutter door 50 closed, pusher bar 210 in the elevated position and the cutter head 100 positioned so that cutter teeth 104 will engage the soil to a desired depth and will break the soil into smaller ground fragments. If desired, the direction of rotation of cutter 100 may be reversed. In order to reverse direction of the cutter head 100, the cutter head 100 is disconnected and is rotated end to end and reattached. Hoses are connected to hydraulic motors 150 and 150a to cause rotation in a clockwise direction as viewed in FIG. 1. When cutter drum 100 is rotating in a clockwise direction as viewed in FIG. 1, cutter door 60 will be in the closed position. Vehicle 15 may be moved in the forward or rear direction and in each instance the chunks of ground, ice or other material will be carried by the cutter teeth 104 which will cause chunks to be impacted by wear plates 72, 84 and 172 and broken into smaller ground fragments suitable for the desired purpose such as road construction, construction of buildings or other desired use. If necessary, ground breaking apparatus 10 may travel over the same path a plurality of times to achieve the desired surface preparation and fragment size. Cutter assembly 20 thus includes removable wear plates positioned and oriented to engage ground fragments carried by the cutter teeth 104 in both directions of rotation of cutter head 100. The wear plates may be described as wear plates having oppositely impacting wear surfaces.

Thus, the present invention is well adapted to carry out the objects and attain the ends and advantages mentioned as well as those inherent therein. While numerous changes may be made by those skilled in the art, such changes are encompassed within the spirit of this invention as defined by the appended claims.

What is claimed is:

1. A ground breaking apparatus comprising:
a powered vehicle;
a rotatable cutter head attached to the vehicle, the cutter head including a plurality of teeth;
a cutter shell surrounding at least a portion of the cutter head;
a plurality of first wear plates having a first wear plate impact surface secured to the cutter shell for impacting ground pieces carried by the teeth; and
a plurality of second wear plates having a second wear plate surface secured to the cutter shell for impacting ground pieces carried by the cutter teeth, wherein the first wear plates are oriented so that the first wear plate surfaces will impact ground pieces carried by the cutter teeth when the cutter head is rotating in a first direction, and wherein the second wear plates are oriented so that the second wear plate surfaces will impact ground pieces carried by the cutter teeth when the cutter head is rotating in a second direction opposite the first direction.

2. The ground breaking apparatus of claim 1, further comprising a cutter door pivotably attached to the cutter shell and movable between open and closed positions, wherein when the door is in the open position, at least a portion of the cutter teeth are exposed for engaging trees and other upstanding objects extending upwardly from the ground being prepared.

3. The ground breaking apparatus of claim 1 further comprising a pusher bar movable between a raised and operating position for engaging trees ahead of the cutter head.

4. The ground breaking apparatus of claim 3, wherein in the operating position the pusher bar extends forward of the cutter head.

5. The ground breaking apparatus of claim 1, wherein the cutter head is an adjustable height cutter head.

6. The ground breaking apparatus of claim 1 wherein the vehicle has an auxiliary engine unit mounted thereto, and wherein the cutter head is driven by the auxiliary engine unit.

7. A ground breaking apparatus comprising:
a vehicle;
a rotatable cutter drum movable with the vehicle;
a plurality of cutter teeth mounted to the cutter drum; and
a cutter shell covering a portion of the cutter drum and defining a radial space therebetween, wherein the direction of rotation of the cutter drum relative to the cutter shell is reversible.

8. The ground breaking apparatus of claim 7 further comprising a plurality of wear plates for engaging ground fragments carried by the cutter teeth, wherein the wear plates are oriented so that a portion of the wear plates engages ground fragments when rotation of the cutter drum is in a first direction, and a portion of the wear plates engage ground fragments when rotation of the cutter drum is in a second direction.

9. The ground breaking apparatus of claim 8 wherein the cutter drum is a generally cylindrical drum with first and second ends, and wherein the direction of rotation of the cutter drum may be reversed by rotating the cutter drum in the cutter shell end to end 180°.

10. The ground breaking apparatus of claim 7 further comprising a cutter door movable from an open and closed position on the cutter shell for selectively exposing and covering a portion of the cutter drum.

11. The ground breaking apparatus of claim 10 further comprising an auxiliary engine unit movable with the vehicle for rotating the cutter drum.

12. The ground breaking apparatus of claim 8 wherein the wear plates are removably attached to the cutter shell.

13. The ground breaking apparatus of claim 10 wherein the cutter teeth will engage standing trees when the door is in the open position.

14. The ground breaking apparatus of claim 13 further comprising a pusher bar movable between a forward, operating position and an elevated position, wherein in the operating position the pusher bar will engage standing trees in advance of the cutter drum.

15. A ground breaking assembly comprising:
a cutter assembly adapted to be connected to a moving vehicle, the cutter assembly comprising:
a rotatable cutter drum;
a plurality of cutter teeth mounted on the cutter drum;
a cutter shell covering at least a portion of the cutter drum; and
a plurality of removable wear plates mounted to the cutter shell, wherein the removable wear plates are positioned and oriented so that at least a portion of the wear plates will engage ground pieces carried by the cutter teeth when the cutter drum is rotating in a forward direction, and at least a portion of the wear plates will engage ground pieces carried by the cutter teeth when the cutter drum is rotating in a reverse direction.

16. The ground breaking assembly of claim 15 further comprising a cutter door pivotably attached to the cutter shell, the cutter door having at least one of the removable wear plate mounted thereto.

17. The ground breaking assembly of claim 15 further comprising a pusher bar pivotably connected to the cutter shell, wherein the pusher bar is movable between an elevated position and an operating position, wherein in the operating position the pusher bar will engage trees in the path of a vehicle to which the ground breaking apparatus is attached when the vehicle is moving in a forward direction.

18. The ground breaking assembly of claim 15 wherein the direction of rotation of the cutter drum is reversible relative to the cutter housing.

19. The ground breaking assembly of claim 19, wherein the direction of rotation of the cutter drum is reversed by rotating the cutter drum end to end in the cutter shell.

20. The ground breaking apparatus of claim 17, wherein the cutter teeth will engage trees and other upstanding objects when the cutter door is open and the vehicle to which the cutter assembly is attached moves in a forward direction.

21. The apparatus of claim 7 comprising a pair of wobble plates operably associated with the cutter drum for maintaining alignment of opposed ends of the cutter drum.
